(19) United States
(12) Patent Application Publication
(10) Pub. No.: US 2006/0178156 A1
(43) Pub. Date: Aug. 10, 2006

(54) Routing method in a wireless sensor network

(75) Inventor: Hyung-Seok Kim, Seoul (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., Suwon-si (KR)

(21) Appl. No.: 11/333,386

(22) Filed: Jan. 17, 2006

(30) Foreign Application Priority Data
Jan. 18, 2005 (KR) 2005-0004385

(51) Int. Cl. H04Q 7/20

(52) U.S. Cl. 455/466

(57) ABSTRACT

A routing method in a wireless sensor network where sensor nodes are grouped into cells is provided. Upon receipt of detected information to be transmitted to a destination, a sensor node determines whether a cell to which the destination belongs is one hop away. If the cell of the destination is not one hop away, the sensor node selects a cell set close to the destination from available neighbor cells to which the detected information can be forwarded, selects a cell from the cell set according to energy densities of the cells in the cell set, and forwards the detected information to a main sensor node of the selected cell.

### PRIORITY

This application claims priority under 35 U.S.C. § 119 to an application filed in the Korean Intellectual Property Office on Jan. 18, 2005 and assigned Serial No. 2005-4385, the contents of which are incorporated herein by reference.

### BACKGROUND OF THE INVENTION

1. Field of the Invention

The present invention relates generally to a routing method in a wireless sensor network, and in particular, to a routing method for increasing system lifetime using cellular energy density in a wireless sensor network.

2. Description of the Related Art

In a wireless sensor network, at least hundreds of small sensor nodes are deployed over a wide area to gather and transmit environmental data to a remote information collector. The wireless sensor network finds its use in the military, natural environment measuring and emergency monitoring applications. The sensor nodes forward data from one sensor node to another as well as generate environmental information.

Routing is the process of transmitting data generated from a sensor node being a data source to a remote information collector that needs the data in the wireless sensor network. Therefore, the wireless sensor network needs a routing protocol by which to set up an optimal route for data transmission.

Traditional routing methods for selecting an optimal route in the wireless sensor network are proactive routing, reactive routing, geographic routing and multi-path routing.

In proactive routing, each sensor node computes the cost of reaching every other sensor node in the shortest path and stores the cost in a routing table. Later, it routes data based on the costs of the other sensor nodes in the routing table. Routing table updates are periodically transmitted throughout the network. Destination Sequenced Distance Vector (DSDV) is a typical example of proactive routing.

In contrast to proactive routing protocols, reactive routing protocols create routes only when desired. Upon receipt of a route request, a sensor node broadcasts a signal to every other sensor node and detects a neighbor sensor node having the shortest distance, to thereby set up a route. Once a route has been established, this route is fixedly used for routing. Ad-hoc On-demand Distance Vector (AODV) is a typical example of reactive routing.

Geographic routing uses sensor node locations. For routing, a sensor node receiving a data packet selects a neighbor sensor node that has the shortest distance to a destination based on the locations of the neighbor sensor nodes.

In multi-path routing, packets with the same source and destination are allowed to take more than one path, each path with a random probability, as illustrated in FIG. 1.

In general, the time required to deplete the battery power of a sensor node in the wireless sensor network is defined as system lifetime. Since the sensor nodes have limited resources that cannot be charged, and particular sensor nodes in the shortest path are exclusively used in the above routing schemes, the lifetime of the wireless sensor network is shortened.

The DSDV manages routing tables. To share routing information, each sensor node periodically transmits its routing information to every other sensor node. Therefore, the DSDV suffers from large battery power consumption due to its inherent characteristic of using many sensor nodes having a small memory capacity. Moreover, since the battery power is not uniformly consumed across the sensor nodes and an optimal path is constantly used, the battery lifetimes of particular sensor nodes are shortened.

Despite consuming less power as compared to the DSDV, a drawback of the AODV is that the fixed use of an established route decreases the battery lifetimes of sensor nodes in the route, relative to the sensor nodes outside the route.

The geographic routing based on the location information of neighbor sensor nodes is favored due to less memory capacity requirement and less power consumption relative to the AODV and the DSDV. However, since a route is established by searching for shortest-distance sensor nodes and data is routed only in the specific route, the geographic routing also reduces the battery lifetimes of particular sensor nodes.

Moreover, the multi-path routing does not concentrate on particular sensor nodes because multiple paths are taken simultaneously. Nonetheless, sensor nodes residing at the intersections of multiple paths, such as a sensor node 101 with concentrated power consumption have shortened battery lifetimes.

As described above, since only particular sensor nodes are exclusively used, their power consumption is relatively large. When they lose their residual power, information cannot be collected from the areas of the sensor nodes. In addition, data routing via the sensor nodes is impossible and thus a communication network becomes disrupted. As a result, communications are disconnected or delayed until a new communication path is established.

### SUMMARY OF THE INVENTION

An object of the present invention is to substantially solve at least the above problems and/or disadvantages and to provide at least the advantages below. Accordingly, an object of the present invention is to provide a method of preventing concentrated power consumption of particular sensor nodes in a wireless sensor network.

Another object of the present invention is to provide a method of preventing concentrated power consumption of particular sensor nodes by monitoring the residual energy levels of sensor nodes in a wireless sensor network.

A further object of the present invention is to provide a routing method for grouping total sensor nodes into cells and routing data, taking into account the energy levels of sensor nodes in the cells.

According to the present invention, in a routing method in a wireless sensor network where sensor nodes are grouped into cells, upon receipt of detected information to be transmitted to a destination, a sensor node determines whether a cell to which the destination belongs is one hop away. If the cell of the destination is more than one hop away, the sensor node groups a cell set which includes available neighbor cells to which the detected information can be forwarded, selects a cell from the cell set according to energy densities of the cells in the cell set, and forwards the detected information to a main sensor node of the selected cell.

According to the present invention, in a routing method in a wireless sensor network where sensor nodes are grouped into cells, upon receipt of detected information to be transmitted to a destination, a sensor node determines whether a cell to which the destination belongs is one hop away. If the cell of the destination is more than one hop away, the sensor node groups a cell set which includes available closest neighbor cell(s) to which the detected information can be forwarded, selects a cell from the cell set according to energy densities of the cells in the cell set if the cells are more than one, and forwards the detected information to a main sensor node of the selected cell.

According to the present invention, in a method of exchanging energy level information for a sensor node in a wireless sensor network system where sensor nodes are grouped into cells, a sensor node transmits energy level change information to neighbor cells and sensor nodes within its cell. Upon receipt of energy level change information from a neighbor sensor node, the sensor node accesses a neighbor node table in which it updates the energy level of the neighbor sensor node.

### BRIEF DESCRIPTION OF THE DRAWINGS

The above and other objects, features and advantages of the present invention will become more apparent from the following detailed description when taken in conjunction with the accompanying drawings in which:

FIG. 1 illustrates a conventional multipath routing method;

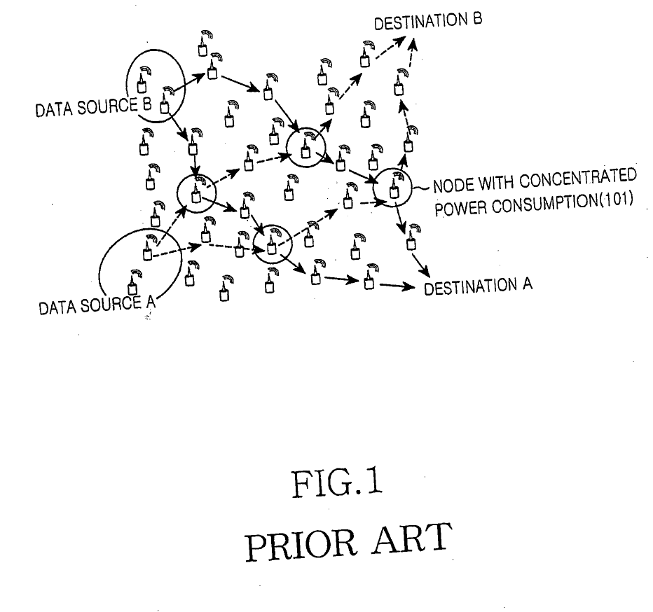

FIG. 2 illustrates a routing method using cellular energy density in a wireless sensor network system according to the present invention;

FIG. 3 is a flowchart illustrating a routing operation based on cellular energy density in the wireless sensor network according to the present invention;

FIG. 4 is a flowchart illustrating an operation for updating an energy level table according to the change of energy level of a sensor node in the wireless sensor network according to the present invention; and

FIG. 5 is a graph illustrating performance improvement according to the present invention.

### DETAILED DESCRIPTION OF THE PREFERRED EMBODIMENTS

Preferred embodiments of the present invention will be described herein below with reference to the accompanying drawings. In the following description, well-known functions or constructions are not described in detail for the sake of clarity and conciseness.

The present invention is intended to provide a technique for lengthening system lifetime in a wireless sensor network. Particularly, a routing method is provided for preventing concentrated use of particular sensor nodes and thus preventing the decrease of their battery lifetimes by grouping total sensor nodes into cells and monitoring the energy density of sensor nodes in each cell.

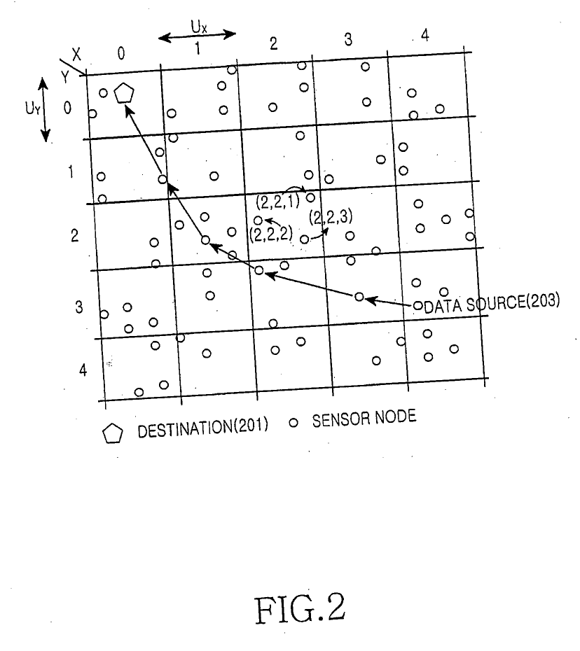

FIG. 2 illustrates a routing method based on cellular energy density in a wireless sensor network system according to the present invention.

To set up a route in the wireless sensor network, total sensor nodes are first grouped into cells and an address is assigned to each sensor node on a cell basis. This is because it is impossible to assign a unique global address to each sensor node due to overhead arising from the dense number of sensor nodes. Since the sensor nodes are usually identified by their geographic locations, the total area of the wireless sensor network is divided into cells and each sensor node within each cell is assigned an address according to the geographic location of the cell. The location of each sensor node can be tracked by a particular sensor node equipped with a Global Positioning System (GPS) function.

Referring to FIG. 2, each cell is defined by a grid and the position of a sensor node within each cell is expressed as (x, y, n) where x and y denote the coordinates of the cell and n denotes the unique address of the sensor node in the cell. For example, the sensor nodes in a cell (2, 2) are assigned (2, 2, 1), (2, 2, 2) and (2, 2, 3), respectively. To prevent overlapping between cells, the cells are defined by grids.

To assign an address to each sensor node, a cell size is determined as follows.

The unit dimensions of a cell that allows a sensor node in a cell to directly communicate with the sensor nodes of G neighbor cells are determined by the following Equations 1 and 2. Here, G is the number of cells one hop away from the sensor node.
uₓ²+u_{y}²≦rₘₐₓ²/(L+1)² (1)
where Uₓ denotes the unit latitudinal length of the cell, U_{y} denotes the unit longitudinal length of the cell, L denotes the closeness between cells, and rₘₐₓ denotes a maximum distance for transmitting a data packet. That is, rₘₐₓ is the maximum distance for which the sensor node can transmit data wirelessly at one hop.
G=4L(L+1) (2)
where G denotes the number of cells one hop away and L denotes the closeness between cells. For L=1, eight neighbor cells exist. For L=2, 24 neighbor cells are present.

To collect information about a particular area 203 from a destination 201, the destination 201 transmits a request packet. A router sensor node being a main sensor node in each cell receiving the request packet determines whether the area 203 is associated with any sensor node within the cell. If the area 203 is associated with a sensor node within the cell, the router sensor node transmits the request packet to the sensor node.

On the other hand, if the area is associated with none of the sensor nodes within the cell, the router sensor node forwards the request packet to another cell. The router sensor node is a sensor node with the highest energy level among the sensor nodes within the cell, and the request packet takes the form of a query (attribute, associated area and requesting area). For example, if the request packet says “Send the average temperature of (x1, y1: x2, y2) to (x3 y3), the average temperature corresponds to attribute, (x1, y1: x2, y2) to associated area, and (x3 y3) to requesting area. When needed, the request packet may further indicate a desired update period.

As described above, upon receipt of the request packet, the router sensor node searches an attribute table such as Table 1, listing the attributes of all the sensor nodes in the cell, and transmits the request packet according to the search result.

Upon receipt of the request packet, the sensor node 203 creates the requested information and forwards it to a neighbor cell having the highest energy density, referring to a neighbor node table and a neighbor cell table preserved by the sensor node 203. The router sensor node of the neighbor cell selects a cell referring to its neighbor node table and a neighbor cell table and forwards the received information to the selected cell. By repeating this procedure, the detected information reaches the destination. Each sensor node has a neighbor node table and a neighbor cell table. Here, a neighbor cell is defined as an adjacent cell having sensor nodes within the wireless radius of the cell.

Table 1 below is an example of a neighbor node table.

TABLE 1

| Neighbor node | Cell | Energy level | Attributes |
|---|---|---|---|
| (22, 24, 1) | Same cell | 4 | Light |
| (22, 24, 2) | Same cell | 3 | Acoustic |
| (22, 25, 1) | Neighbor cell 2 | 4 | N/A |
| (21, 24, 1) | Neighbor cell 3 | 2 | N/A |
| (21, 24, 2) | Neighbor cell 3 | 0 | N/A |
| . . . | . . . | . . . | . . . |

The neighbor node table includes information about neighbor sensor nodes. “neighbor node” provides the addresses of neighbor sensor nodes, “Cell” indicates the cells of the neighbor sensor nodes, “Energy level” indicates the current battery energy states of the sensor nodes, and “Attributes” indicates the attributes of sensors in the sensor nodes.

Table 2 is an example of a neighbor cell table.

TABLE 2

| Neighbor cell | ANC to D1 | FC to D1 |
|---|---|---|
| 1 | ◯ | X |
| 2 | ◯ | ◯ |
| 3 | ◯ | X |
| 4 | X | X |
| 5 | ◯ | X |
| . . . | . . . | . . . |

The neighbor cell table provides information about the states of neighbor cells. “Neighbor cell” indicates the indexes of the neighbor cells, and “ANC (Available Neighbor Cell) to D1” indicates neighbor cells that have forwarded the request packet to the cell (D1). Since the neighbor cells set in “ANC to D1” form paths between the destination and the cell D that has received the request packet, “ANC to D1” indicates neighbor cells that can forward the detected information to the destination. “FC (Forwarding Cell) to D1” field indicates a neighbor cell that can forward a data packet from the cell (D1) among the neighbor cells set as ANCs. In Table 2, among neighbor cells 1, 2, 3 and 5 set as ANCs to D1, neighbor cell 2 is chosen as FC to D1 because it is closest to the destination and has the highest energy level.

A description will now be made of a method of transmitting information generated from a source that has received a request packet to a destination. The source refers to a sensor node that generates information requested by the destination, upon receipt of a request packet from the destination.

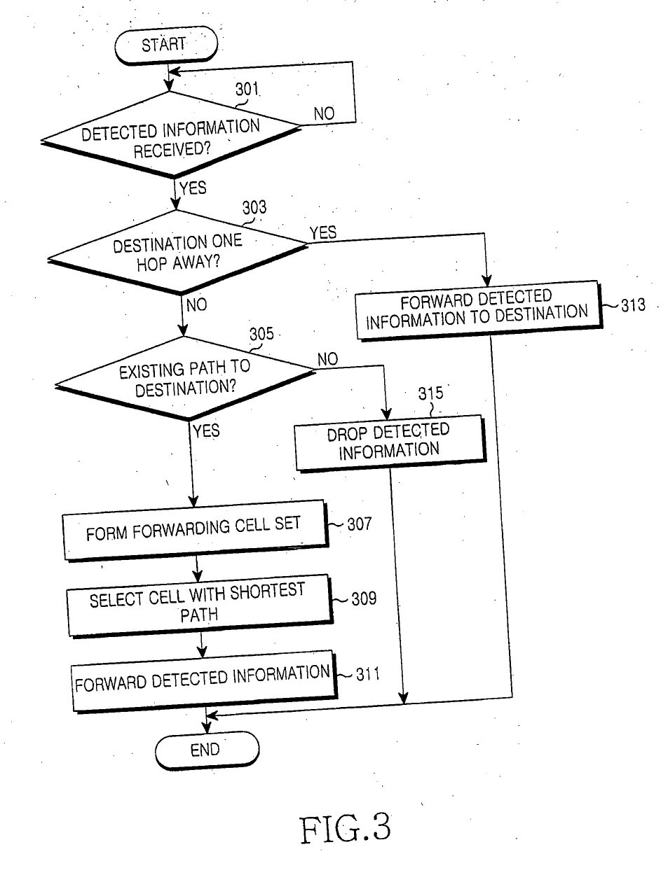

FIG. 3 is a flowchart illustrating a routing operation using cellular energy density in the wireless sensor network according to the present invention.

Referring to FIG. 3, a router sensor node monitors receipt of detected information in step 301.

Upon receipt of the detected information, the router sensor node determines whether a destination is one hop away from cell i to which the router sensor node belongs in step 303, by Equation 3 in which
D∈Vᵢ and d(i,D)≦\sqrt{2}L (3)
where D represents the cell of the destination which transmitted the request packet, Vᵢ represents a set of neighbor cells for cell i, d(i, D) represents the distance between cell i and cell D, L represents the closeness between cells, and \sqrt{2}L represents the maximum distance of one hop.

The router sensor node determines whether cell D to which the destination belongs is included in the neighbor cell set of cell i and whether the distance between cell D and cell i is shorter than \sqrt{2}L.

If the condition described by Equation (3) is fulfilled, the router sensor node directly forwards the detected information to the destination, bypassing the router sensor node of cell D in step 313 and ends this algorithm. Bypassing the router sensor node of cell D prevents unnecessary energy consumption.

However, if the condition is not fulfilled and the destination cannot be reached at one hop, the router sensor node determines whether a route from cell i to the destination exists in step 305 by Equation (4), which describes the condition of the forwarding cell j by which to set up a route to the destination:
j∈Aᵢ⊂Vᵢ (4)
where j represents a forwarding cell to which cell i is to forward the detected information, Aᵢ represents a set of available neighbor cells set as ANC to D as illustrated in Table 2, and Vᵢ represents the neighbor cell set for cell i.

When the condition of Equation (4) is not fulfilled, the router sensor node discards the detected information, because it is impossible to forward the detected information to the destination in step 315, and ends the algorithm.

When the condition of Equation (4) is fulfilled, the router sensor node searches for cells one hop away from cell i and groups the searched cells into a cell set J in step 307.

It is determined whether the distance between cell i and cell j can be covered by one hop by Equation 5, in which
d(i,j)≦\sqrt{2}L (5)

where d(i, j) represents the distance between cell i and cell j. By Equation (5), the router sensor node compares the distance between cell i and cell j with the maximum distance covered by one hop.

The distance between cell i and cell D is compared with the distance between cell j and cell D by Equation 6, in which
d(i,D)>d(j,D) (6)
where d(i, D) represents the distance between cell i and cell D and d(j, D) represents the distance between cell j and cell D. Thus, the router sensor node determines a cell closer to the destination than cell i to be a forwarding cell.

In step 309, the router sensor node selects a cell having the shortest path to the destination among the cells of set J by Equation 7, in which.

$$M ( i , j ) = ad ( j , d ) + β {\{ {\sum }_{m ∈ {S}_{j}} {W}_{E ( j , m )} E ( j , m ) \}}^{- 1} + γ d ( i , j ) \qquad ( 7 )$$

where M(i, j) represents a path determination value, d(j, D) represents the distance between cell j and cell D, and d(i, j) represents the distance between cell i and cell j.

$${\{ {\sum }_{m ∈ {S}_{j}} {W}_{E ( j , m )} E ( j , m ) \}}^{- 1}$$

is the reciprocal of the energy density of cell j, that is, the reciprocal of the sum of the energy levels of sensor nodes in cell j. The reciprocal of energy density is used to select a cell with the shortest d(j, d) and d(i, j) in case of equal energy density. Therefore, a cell having the minimum path determination value is selected. This cell has the highest energy density and the shortest distance to the destination.

In

$${\{ {\sum }_{m ∈ {S}_{j}} {W}_{E ( j , m )} E ( j , m ) \}}^{- 1} ,$$

E(j, m) represents the residual energy level of an m^{th} sensor node in cell j, and W_{E(j,m)} represent weights applied to different energy levels of sensor nodes in cell j. For example, given four sensor nodes in cell j, the sum of energy levels (1, 1, 1, 1) is equal to that of energy levels (4, 0, 0, 0) but if the energy levels are weighted in the two cases, the sums are different. In the present invention, the energy levels are weighted in order to select a sensor node with the highest energy level.

α, β and γ are weights for the respective right terms in the above equation. To render the term related to energy density more significant, the condition that β>>α, γ must be satisfied.

After selecting a cell having the minimum value of M(i, j), that is, a cell having the highest energy density in the cell set J, the router sensor node forwards the router sensor node of the selected cell in step 311 and ends the algorithm.

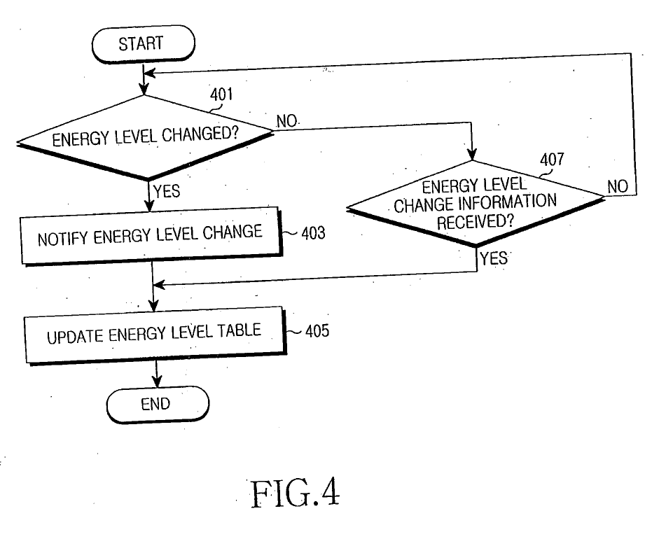

FIG. 4 is a flowchart illustrating an operation for updating an energy level table according to the change of energy level of a sensor node in the wireless sensor network according to the present invention.

Referring to FIG. 4, the sensor node monitors its energy level in step 401.

If the energy level has been changed, the sensor node notifies its cell and neighbor cells of energy level change information in step 403.

The sensor node updates its energy level in the neighbor node table such as Table 1 in step 405.

If the energy level is unchanged, the sensor node determines whether energy level change information has been received from any other neighbor sensor node in step 407.

Upon receipt of the energy level change information, the sensor node updates the energy level of the neighbor sensor node in the neighbor node table such as Table 1 in step 405. A cell having the detected information re-establishes a path to the destination taking into account the energy densities of neighbor cells in the procedure of FIG. 3. Then, the sensor node ends the algorithm.

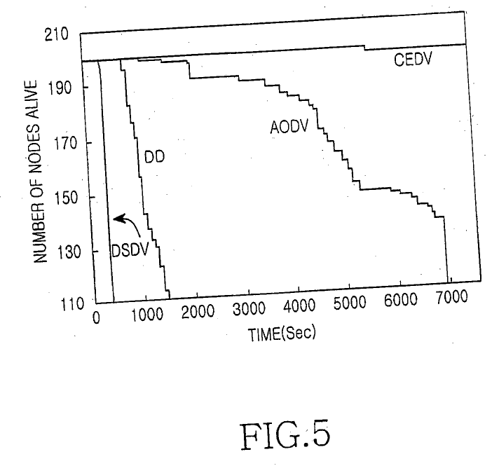

FIG. 5 is a graph illustrating performance improvement according to the present invention.

Referring to FIG. 5, the inventive routing (Cellular Energy Density Vector (CEDV)), Directed Diffusion (DD) applicable to the wireless sensor network, AODV, and DSDV were operated for an extended period of time and the number of working sensor nodes still operating in each routing scheme was counted. As noted from FIG. 5, system lifetime is longer in CEDV than in any other routing scheme.

In accordance with the present invention as described above, a communication path is established by monitoring the residual energy densities of cells in a wireless sensor network such that power consumption is uniform across the network without concentrating power consumption on particular sensor nodes. Therefore, the lifetime of the wireless sensor network is lengthened and the sensing durations of the sensor nodes with limited battery energy are increased. In addition, a data path is maintained without interruptions.

Furthermore, the availability duration of the wireless sensor network is also increased, in which the sensor nodes are deployed randomly over a wide area, facilitating easy repair and maintenance.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. A routing method for a sensor node in a wireless sensor network where sensor nodes are grouped into cells, comprising the steps of:
(1) determining, upon receipt of detected information to be transmitted to a destination, whether a cell to which the destination belongs is one hop away;
(2) grouping a cell set which includes available neighbor cells to which the detected information can be forwarded, if the cell of the destination is more than one hop away; and
(3) selecting a cell from the cell set according to energy densities of the cells in the cell set and forwarding the detected information to a main sensor node of the selected cell.

2. The routing method of claim 1, wherein the sensor node has a first table listing energy levels and attributes of neighbor sensor nodes and a second table indicating a presence or an absence of a path for routing to the destination.

3. The routing method of claim 1, wherein step (2) further comprises:
determining whether a forwarding cell to which the detected information is to be forwarded is a neighbor cell;
comparing a first distance between the sensor node and the destination with a second distance between the forwarding cell and the destination; and
grouping neighbor cells having the second distance shorter than the first distance into the cell set.

4. The routing method of claim 1, wherein step (1) further comprises:
determining whether the detected information can be conveyed to the cell of the destination at one hop by computing
d(i,j)≦\sqrt{2}L
where d(i, j) represents a distance between cell i of the sensor node and cell j of the destination and \sqrt{2}L represents a maximum distance that can be covered by one hop; and
determining that the detected information can be conveyed to the cell of the destination, if d(i, j)≦\sqrt{2}L.

5. The routing method of claim 1, further comprising the step of, if the detected information can be conveyed to the cell of the destination by one hop, directly transmitting the detected information to the destination, bypassing a sensor node having a highest residual energy level in the cell of the destination.

6. The routing method of claim 1, wherein the main sensor node of the selected cell is a sensor node having a highest energy level in the selected cell.

7. The routing method of claim 1, wherein the sensor nodes are grouped into cells such that the cells do not overlap.

8. The routing method of claim 1, wherein the sensor nodes are assigned addresses on a cell basis.

9. A method of exchanging energy level information for a sensor node in a wireless sensor network system where sensor nodes are grouped into cells, comprising the steps of:
transmitting, if the energy level of the sensor node is changed, energy level change information to neighbor cells and sensor nodes within a cell to which the sensor node belongs; and
accessing a neighbor node table, upon receipt of energy level change information from a neighbor sensor node, and updating the energy level of the neighbor sensor node in the neighbor node table.

10. The method of claim 9, wherein the neighbor node table includes information about the energy levels and attributes of neighbor sensor nodes.

11. A routing method for a sensor node in a wireless sensor network where sensor nodes are grouped into cells, comprising the steps of:
(1) determining, upon receipt of detected information to be transmitted to a destination, whether a cell to which the destination belongs is one hop away;
(2) grouping a cell set which includes available closest neighbor cell(s) to which the detected information can be forwarded, if the cell of the destination is more than one hop away; and
(3) selecting a cell from the cell set according to energy densities of the cells in the cell set if the cells are more than one and forwarding the detected information to a main sensor node of the selected cell.

12. The routing method of claim 11, wherein the sensor node has a first table listing energy levels and attributes of neighbor sensor nodes and a second table indicating a presence or an absence of a path for routing to the destination.

13. The routing method of claim 11, wherein step (2) further comprises:
determining whether a forwarding cell to which the detected information is to be forwarded is a neighbor cell;
comparing a first distance between the sensor node and the destination with a second distance between the forwarding cell and the destination; and
grouping neighbor cells having the second distance shorter than the first distance into the cell set.

14. The routing method of claim 11, wherein step (1) further comprises:
determining whether the detected information can be conveyed to the cell of the destination at one hop by computing
d(i,j)≦\sqrt{2}L
where d(i, j) represents a distance between cell i of the sensor node and cell j of the destination and \sqrt{2}L represents a maximum distance that can be covered by one hop; and
determining that the detected information can be conveyed to the cell of the destination, if d(i, j)≦\sqrt{2}L.

15. The routing method of claim 11, wherein the main sensor node of the selected cell is a sensor node having a highest energy level in the selected cell.

16. The routing method of claim 11, wherein the sensor nodes are grouped into cells such that the cells do not overlap.

17. The routing method of claim 11, wherein the sensor nodes are assigned addresses on a cell basis.
